(19) United States
(12) Patent Application Publication
(10) Pub. No.: US 2008/0132223 A1
(43) Pub. Date: Jun. 5, 2008

(54) Systems and methods for providing traffic information

(76) Inventors: Chun-Fu Lin, Hsinchu (TW); Chih-Yuan Liu, Hsinchu (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/896,210

(22) Filed: Aug. 30, 2007

Related U.S. Application Data
(60) Provisional application No. 60/872,514, filed on Dec. 4, 2006.

(51) Int. Cl. H04Q 7/20

(52) U.S. Cl. 455/422.1

(57) ABSTRACT

A method distributing traffic information includes: receiving location and identification information from a first wireless device; calculating a speed of the first wireless device; and transmitting data selected from the group consisting of speed, location, and identification information of the first wireless device to a second wireless device.

This application claims benefit of U.S. Provisional Application No. 60/872,514, filed Dec. 4, 2006, the contents of which are incorporated herein by reference.

### BACKGROUND OF THE INVENTION

The method and system disclosed relate to the field of mobile communications, and more specifically, a system for and method of distributing traffic information within a network of wireless communication devices.

### FIELD OF THE INVENTION

Wireless communications devices have become ubiquitous recently, with seemingly every individual fitted with a personal digital assistant having wireless communications capability or with a smart telephone. These wireless devices enable their owners to maintain in communication with a vast array of data networks, such as the Internet. Thus, wireless devices serve as portals for receiving and transmitting data between the user of the wireless device and others in the networked world.

Typically, information exchanged between individuals tends to be voice and data, with data communications including, for example, electronic mail exchange, instant messaging, texting, and browsing the World Wide Web. Despite the growing presence of wireless devices, their use as the source of data gathering and dissemination has not been fully exploited. For example, many users of wireless devices are traveling in cars and thus are aware of various traffic conditions. In addition, some wireless devices have the ability to determine their speed and position through, for example, the Global Positioning System.

While wireless device users in certain cities have the ability to access certain centralized traffice information, for example, Atlanta, Ga. traffic data at the Georgia Navigator at www.georgia-navigator.com, system such as this do not permit the two-way flow of information. In other words, users of the Georgia Navigator cannot submit traffic data to the Georgia Navigator website. Neither can wireless devices transmit traffic data to each other.

### SUMMARY

A method of distributing traffic information is provided. The method comprises: receiving location information and identification information from a first wireless device; calculating speed of the first wireless device; and transmitting one or more of the speed, location, and identification of the first wireless device to a second wireless device.

In accordance with a further embodiment, a system for distributing traffic information is provided. The system comprises: a memory; and a processor, coupled to the memory. The processor is operable to: receive location information and identification information from a first wireless device; calculate speed of the first wireless device; and transmit one or more of the speed, location and identification of the first wireless device to a second wireless device.

In accordance with another embodiment, a method of distributing traffic information is provided. The method comprises: receiving speed and location information from a first wireless device; and transmitting the speed and location of the first wireless device to a second wireless device.

In accordance with a further embodiment, a system for distributing traffic information is provided. The system comprises: a memory; and a processor, coupled to the memory. The processor is operable to: receive speed and location information from a first wireless device; and transmit the speed and location of the first wireless device to a second wireless device.

In accordance with another embodiment, a method of distributing traffic information is provided. The method comprises: receiving identification information from a first wireless device; searching for a second wireless device having identification information that matches the identification information received from the first wireless device; receiving one or more of speed information and location information from the second wireless device; and transmitting one or more of the speed information and location information received from the second wireless device to the first wireless device.

In accordance with a further embodiment, a system for distributing traffic information is provided. The system comprises: a memory; and a processor coupled to the memory. The processor is operable to: receive identification information from a first wireless device; search for a second wireless device that matches the identification information received from the first wireless device; receive one or more of speed information and location information from the second wireless device; and transmit one or more of the speed information and location information received from the second wireless device to the first wireless device.

In accordance with another embodiment, a method of distributing traffic information is provided. The method comprises: receiving location information from a first wireless device; searching for a second wireless device that matches the location information of the first wireless device; and transmitting one or more of speed information and identification information from the second wireless device to the first wireless device.

In accordance with a further embodiment, a system for distributing traffic information is provided. The system comprises: a memory; and a processor, coupled to the memory. The processor is operable to: receive location information from a first wireless device; search for a second wireless device that matches the location information of the first wireless device; and transmit one or more of speed information and identification information from the second wireless device to the first wireless device.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing summary and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate a system consistent with the principles of the invention and, together with the description, serve to explain the principles of the invention.

FIG. 1 is a diagram of a first wireless communications system operating in a client-server mode consistent with the principles of the present invention.

FIG. 2 is a diagram of a second wireless communications system operating in a peer-to-peer mode consistent with the principles of the present invention.

FIG. 3 is a flowchart of a client-server method consistent with the present invention for distributing traffic information.

FIG. 4 is a flowchart of a peer-to-peer method consistent with the present invention for distributing traffic information.

### DESCRIPTION

The principles of the present invention may be understood with reference to this description. Wherever possible, the same reference numbers will be used throughout the drawings to refer to the same or like parts.

The principles of the present invention improve upon prior art traffic reporting systems by distributing location and identification among wireless devices. Wireless devices may communicate location and identification information through a central server in a client-server architecture, or wireless devices may communicate location and identification information among themselves using a peer-to-peer architecture. Embodiments of the traffic information distribution system may also implement a hybrid approach with some information transmitted via client-server communications and other information transmitted via peer-to-peer communications. Similarly, speed of a wireless device may be calculated by the wireless device and transmitted to other devices, or the central server or other devices may calculate the speed of the wireless device based on the changing location information transmitted by the wireless device. Those skilled in the art may now appreciate that information in addition to speed, location, and identification may be distributed among wireless devices, and that the information distributed among wireless devices may also be provided to clients external to the wireless communications system.

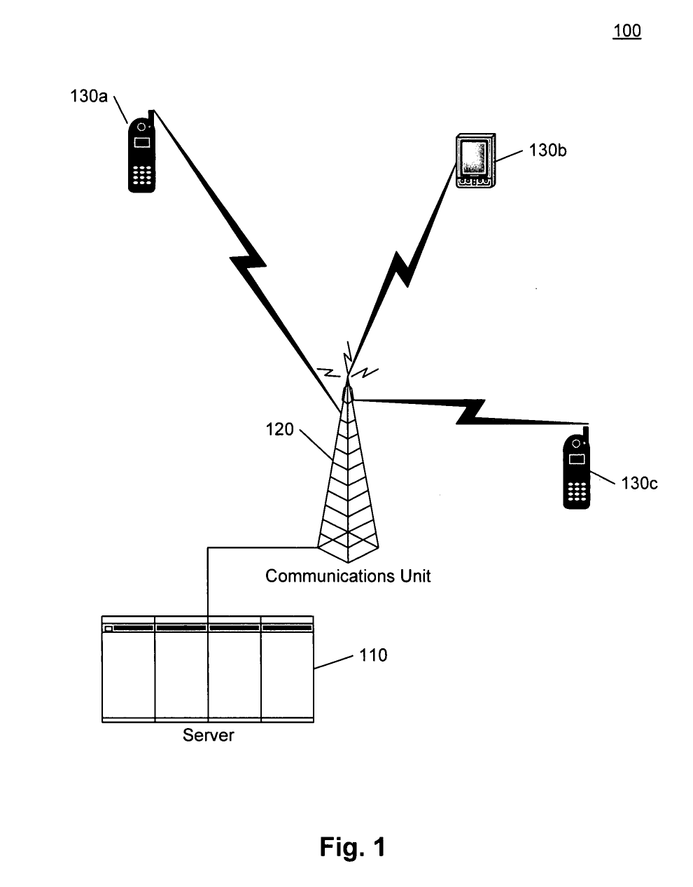

FIG. 1 is a diagram of a first wireless communications system 100 operating in a client-server mode consistent with the principles of the present invention. A server 110 may include a processor in communication with a memory device. Methods of the present invention may be stored as instructions in the memory device of server 110 for execution by the processor of server 110. Server 110 may also include communications interfaces to networks, such as the Internet for example. Server 110 communicates with one or more wireless devices 130a-c using a communications unit 120.

Communications unit 120 may communicate with wireless devices 130a-c using radio frequency communication and communications systems and protocols, such as, for example, WIFI (e.g., IEEE 802.11a, b, c, g, or n), WiMax (e.g., IEEE 802.16), GSM, GPRS, 3G (e.g., UMTS, CDMA2000, and Wideband CDMA), and 4G systems. Wireless devices 130a-c may comprise a processor coupled to a memory for storing and executing instructions for implementing embodiments of the present invention. Wireless devices 130a-c may also include a radio frequency communications interface, coupled to the processor, for communicating with communications unit 120. Wireless devices 130a-c may also include a locating device, such as a Global Positioning System (GPS) receiver or may calculate location based on less direct methods such as triangulation of signal strength of multiple communications towers. Wireless devices 130a-c may be, for example, personal digital assistants (PDA's), smart phones, user devices, computers, or Global Positioning System (GPS) devices.

In wireless communications system 100 of FIG. 1, wireless communication devices 130a-c may periodically transmit location and identification information to server 110. Location information includes the location of the wireless device. Identification information is information sufficient to uniquely identify the wireless device within a given geographical region, for example, within a particular city or neighborhood within a city. The server 110 may use the location and identification information to calculate a speed of the wireless device. Alternatively, the communications device may calculate and transmit speed information to server 110. Server 110 sends one or more of the received location, speed, and identification information to at least one other wireless device, so that the other wireless device learns of traffic information. Thus, multiple wireless devices 130a-c may exchange information regarding traffic information using server 110.

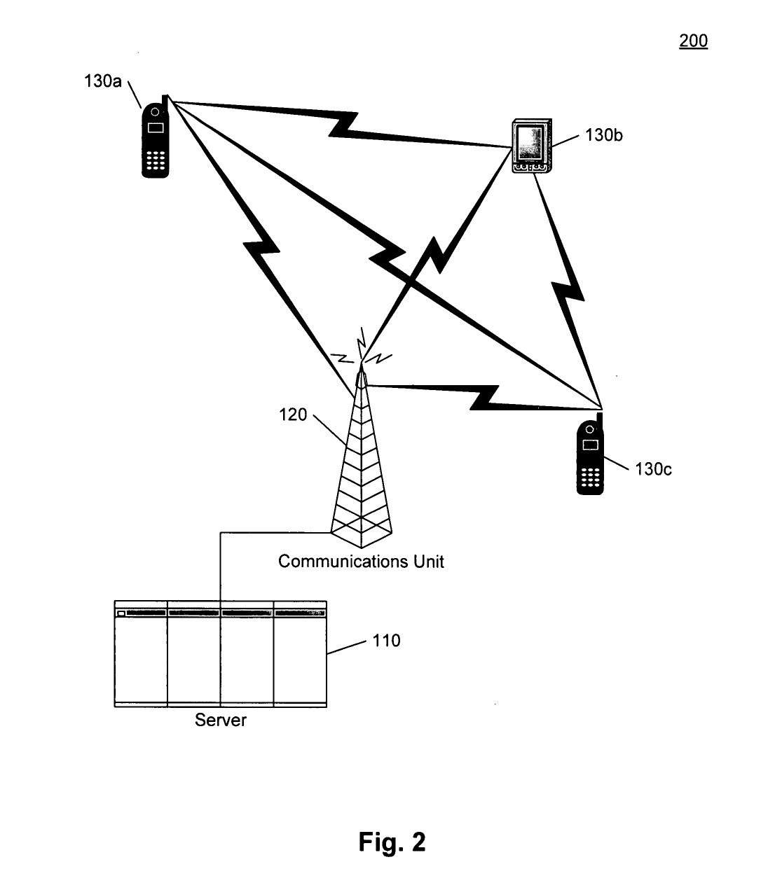

FIG. 2 is a diagram of a second wireless communications system 200 operating in a peer-to-peer mode consistent with the principles of the present invention. As in the first system of FIG. 1, second wireless communications system 200 is utilized to exchange traffic information between multiple wireless devices 130a-c, without the necessity of a server 110. Server 110 may be present, for example, to facilitate identification of wireless devices to each other, to centrally monitor, gather, and distribute traffic information from wireless devices 130a-c to outside systems, such as over the Internet, or to distribute other information to wireless devices 130a-c. However, second wireless communications system 200 operates on a peer-to-peer basis by communicating information, such as location, identification, or speed, between wireless devices 130a-c, without the need for a central server. As in wireless communications system 100, receiving devices, for example wireless device 130c, may compute speed based on changing location or sending devices may compute and transmit speed.

In addition, both wireless communications systems 100 and 200 may use server 110 to provide traffic information to other users. Other users may include, for example, commercial business organizations, government entities, or private persons. In addition, server 110 may receive information from outside sources, such as a government traffic control center, and provide the received information to one or more wireless devices 130a-c. For example, the government traffic control center may track accident information, send that information to server 110, which may in turn distribute it to one or more wireless devices 130a-c.

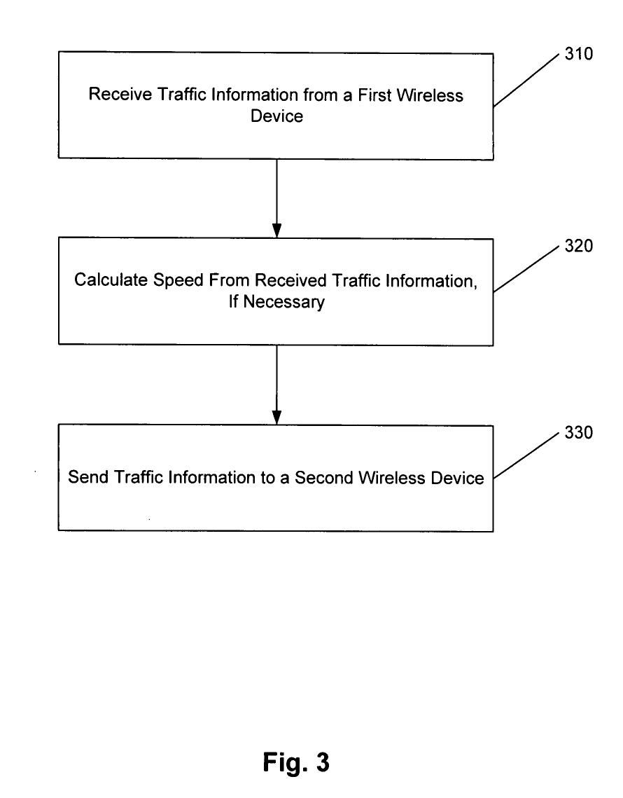

FIG. 3 is a flowchart of a client-server method consistent with the present invention for distributing traffic information. Traffic information is received from a first wireless device (stage 310). The traffic information may include, for example, location and identification information, as previously described. In addition, the traffic information received may include speed information. If speed information is not received, speed is calculated based on, for example, at least the differential value of two receptions of location information from the same wireless device (stage 320). The speed information, related to either the location or identification information received from the first wireless communication device may be stored in the server. The traffic information of a specified location or identification may be retrieved from the server and may be transmitted to a second wireless device, where the information may include, for example, one or more of speed, location, and identification information (stage 330). The specified location or identification may be assigned by either the first wireless device, the second wireless device, or the server. In this fashion, traffic information may be distributed among wireless devices using client-server methodology.

While not illustrated, additional stages may be present in the above method. For example, additional information may be received from external information providers, such as government traffic control center's and transmitted to the wireless devices in stage 330.

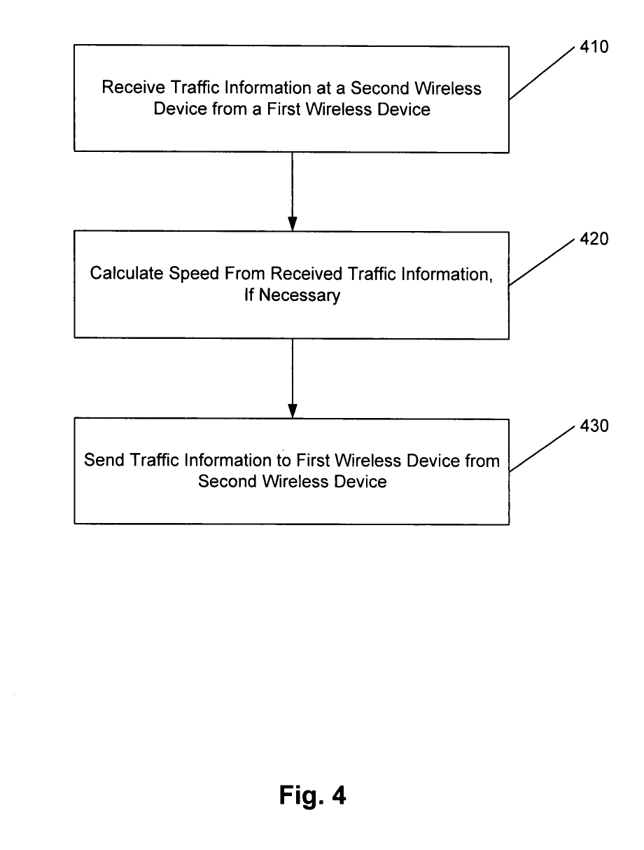

FIG. 4 is a flowchart of a peer-to-peer method consistent with the present invention for distributing traffic information. Traffic information is received by a second wireless device from a first wireless device (stage 410). The traffic information may include, for example, location and identification information, as previously described. In addition, the traffic information received may include speed information. If speed information is not received, speed is calculated based on, for example, at least the differential value of two receptions of location information from the same wireless device (stage 420). Traffic information is then transmitted by the second wireless device to the first wireless device, where this traffic information may include, for example, location and identification information, as well as speed information (stage 430). In this fashion, traffic information may be distributed among wireless devices using peer-to-peer methodology. While not illustrated, the first and second wireless device may transmit traffic information to a server.

In any embodiments consistent with the principles of the present invention, the server may maintain a relationship table of the wireless device identification information and its location information. In this fashion, the server could introduce a second wireless device that matches the location or identification information specified by a first wireless device to the first wireless device for exchanging traffic information.

Those skilled in the art will appreciate that all or part of systems and methods consistent with the present invention may be stored on or read from other computer-readable media, such as: secondary storage devices, like hard disks, floppy disks, flash storages, CD, or DVD; a carrier wave received from the Internet; or other forms of computer-readable memory, such as read-only memory (ROM), random-access memory (RAM), or magnetic RAM.

Furthermore, one skilled in the art will also realize that the processes illustrated in this description may be implemented in a variety of ways and include multiple other modules, programs, applications, scripts, processes, threads, or code sections that all functionally interrelate with each other to accomplish the individual tasks described above for each module, script, and daemon. For example, it is contemplated that these programs modules may be implemented using commercially available software tools, using custom object-oriented, using applets written in the Java programming language, or may be implemented as with discrete electrical components or as at least one hardwired application specific integrated circuits (ASIC) custom designed just for this purpose.

It will be readily apparent to those skilled in this art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

We claim:

1. A method of distributing traffic information, comprising:
receiving location and identification information from a first wireless device;
calculating a speed of the first wireless device; and
transmitting data selected from the group consisting of speed, location, and identification information of the first wireless device to a second wireless device.

2. The method of claim 1, wherein the location information comprises the location of the first wireless device.

3. The method of claim 1, wherein the identification information comprises an identifier sufficient to uniquely identify the first wireless device within a geographic region.

4. The method of claim 1, further comprising receiving second wireless device location and second wireless device identification information from the second wireless device.

5. The method of claim 4, further comprising calculating a second wireless device speed of the second wireless device.

6. The method of claim 5, further comprising transmitting second wireless device data selected from the group consisting of second wireless device speed, second wireless device location, and second wireless device identification of the second wireless device to the first wireless device.

7. The method of claim 1, further comprising receiving traffic information from a traffic center.

8. The method of claim 7, further comprising sending the received traffic information to the first wireless device.

9. The method of claim 1, further comprising sending data selected from the group consisting of speed, location, and identification information of the first wireless device to a user.

10. The method of claim 1, wherein calculating a speed of the wireless device comprises:
receiving a second location from the first wireless device; and
calculating speed as the differential distance between the location and the second location of the first wireless device, divided by the differential time between when the location and the second location was received from the first wireless device.

11. A system for distributing traffic information, comprising:
a memory; and
a processor coupled to the memory, wherein the processor has the capability of:
receiving location information and identification information from a first wireless device;
calculating speed of the first wireless device; and
transmitting one or more of the speed, location and identification of the first wireless device to a second wireless device.

12. The system of claim 11, wherein the location information comprises the location of the first wireless device.

13. The system of claim 11, wherein the identification information comprises an identifier sufficient to uniquely identify the first wireless device within a geographic region.

14. The system of claim 11, wherein the processor is further operable to receive a second wireless device location and a second wireless device identification information from the second wireless device.

15. The system of claim 14, wherein the processor is further capable of calculating a second wireless device speed of the second wireless device.

16. The system of claim 15, wherein the processor is further capable of transmitting a second wireless device data selected from the group consisting of second wireless device speed, second wireless device location, and second wireless device identification of the second wireless device to the first wireless device.

17. The system of claim 11, wherein the processor is further capable of receiving traffic information from a traffic center.

18. The system of claim 17, wherein the processor is further capable of sending the received traffic information to the first wireless device.

19. The system of claim 11, wherein the processor is further capable of sending data selected from the group consisting of speed, location, and identification information of the first wireless device to a user.

20. The system of claim 11, wherein the processor is further capable of:
receiving a second location from the first wireless device; and
calculating speed as the differential distance between the location and the second location of the first wireless device, divided by the differential time between when the location and the second location was received from the first wireless device.

21. A method of distributing traffic information, comprising:
receiving speed and location information from a first wireless device; and
transmitting the speed and location of the first wireless device to a second wireless device.

22. The method of claim 21, wherein the location information comprises the location of the first wireless device.

23. The method of claim 21, further comprising receiving second wireless device location and second wireless device speed information from the second wireless device.

24. The method of claim 23, further comprising transmitting second wireless device speed and second wireless device location information to the first wireless device.

25. The method of claim 21, further comprising receiving traffic information from a traffic center.

26. The method of claim 25, further comprising sending the received traffic information to the first wireless device.

27. The method of claim 21, further comprising sending speed and location information of the first wireless device to a user.

28. A system for distributing traffic information, comprising:
a memory; and
a processor coupled to the memory, wherein the processor is capable of:
receiving speed and location information from a first wireless device; and
transmitting the speed and location of the first wireless device to a second wireless device.

29. The system of claim 28, wherein the location information comprises the location of the first wireless device.

30. The system of claim 28, wherein the processor is further capable of receiving second wireless device location and second wireless device speed information from the second wireless device.

31. The system of claim 30, wherein the processor is further capable of transmitting second wireless device speed and second wireless device location information to the first wireless device.

32. The method of claim 28, further comprising receiving traffic information from a traffic center.

33. The system of claim 32, wherein the processor is further capable of sending the received traffic information to the first wireless device.

34. The system of claim 28, wherein the processor is further capable of sending speed and location information of the first wireless device to a user.

35. A method of distributing traffic information, comprising:
receiving identification information from a first wireless device;
searching for a second wireless device having identification information that matches the identification information received from the first wireless device;
receiving one or more of speed information and location information from the second wireless device; and
transmitting one or more of the speed information and location information received from the second wireless device to the first wireless device.

36. A system for distributing traffic information, comprising:
a memory; and
a processor coupled to the memory, the processor operable to:
receive identification information from a first wireless device;
search for a second wireless device that matches the identification information received from the first wireless device;
receive one or more of speed information and location information from the second wireless device; and
transmit one or more of the speed information and location information received from the second wireless device to the first wireless device.

37. A method of distributing traffic information, comprising:
receiving location information from a first wireless device;
searching for a second wireless device that matches the location information of the first wireless device; and
transmitting one or more of speed information and identification information from the second wireless device to the first wireless device.

38. A system for distributing traffic information, comprising:
a memory; and
a processor coupled to the memory, wherein the processor is capable of:
receiving location information from a first wireless device;
searching for a second wireless device that matches the location information of the first wireless device; and
transmitting one or more of speed information and identification information from the second wireless device to the first wireless device.
